(19) United States
(12) Patent Application Publication
(10) Pub. No.: US 2015/0265967 A1
(43) Pub. Date: Sep. 24, 2015

(54) Gaseous Mercury Oxidation and Capture

(71) Applicant: NOVINDA CORPORATION, Denver, CO (US)

(72) Inventors: James Robert Butz, Lakewood, CO (US); Michael A. Lucarelli, McMurray, PA (US)

(73) Assignee: Novinda Corporation, Denver, CO (US)

(21) Appl. No.: 14/435,191

(22) PCT Filed: Oct. 9, 2013
(86) PCT No.: PCT/US2013/064027

§ 371 Date: Apr. 13, 2015

Related U.S. Application Data
(60) Provisional application No. 61/714,382, filed on Oct. 16, 2012.

(51) Int. Cl. B01D 53/86; B01D 53/90

(52) U.S. Cl. CPC B01D 53/8665; B01D 53/90; B01D 2257/602; B01D 2255/702; B01D 2255/70; B01D 2255/2045; B01D 2255/20738; B01D 2255/20761; B01D 2258/0283; B01D 2255/2092; B01D 2255/207; B01D 2255/30

(57) ABSTRACT

Described herein is a process for oxidizing gaseous Hg(0) in the combustion gas from a coal fired boiler. The process includes injecting into the combustion gases a particulate mercury oxidant precatalyst. The process further including, oxidizing Hg(0) in the combustion gases to an oxidized mercury selected from the group consisting of Hg(I), Hg(II) and injecting a mercury sorbent that admixes with the oxidized Hg(II) to form a oxidized-mercury/sorbent species. The oxidized-mercury/sorbent species can then be collected from the combustion (flue) gas using standard powder capture technologies.

### CROSS-REFERENCE TO RELATED APPLICATIONS

This disclosure claims the benefit of priority to U.S. Provisional Application 61/714,382 filed Oct. 16, 2012, the disclosure of which is incorporated herein in its entirety.

### FIELD OF THE INVENTION

This disclosure is related to the oxidation and capture of mercury (e.g., carried in flue gas produced from the combustion of coal) with particulate oxidants.

### BACKGROUND

The oxidation state of mercury contained in the flue gas from a coal fired boiler can be Hg(0), Hg(I), and/or Hg(II), and is often a mixture of these three oxidation states. The efficiency of the subsequent removal of mercury in the flue gas by mercury sorbents depends on the chemistry of the sorbent and its reactivity with each of the mercury oxidation states.

Cationic mercury has been proposed to be an easier form of the metal to sequester and remove from the flue gas. Correspondingly many efforts have been directed at providing oxidized mercury in the flue gas. For example, additives have been added to the coal prior to or during combustion in an effort to promote mercury oxidation in or immediately after the boiler (these additives include e.g., calcium bromide and/or calcium chloride). Other examples include the addition of gaseous oxidants to the flue gas downstream of the boiler. Gaseous oxidants include chlorine (Cl₂), and/or hydrochloric acid (HCl).

In “Survey of Catalysts for Oxidation of Mercury in Flue Gas”, Environmental Sci. & Tech., 2006, 40(18), 5601-5609, Presto and Granite reviewed the art of catalytic-mercury oxidation which included (1) the application of selective catalytic reduction (SCR) catalysts, (2) “carbon-based” mercury oxidation on fly ash, and (3) metal/metal oxide based oxidation catalysts. Both the SCR catalysts and the metal/metal oxide based catalysts metal oxides are provided in the flue gas in a fixed-bed or on a honeycomb catalyst support. The “carbon-based” mercury oxidation relies on reactive carbon centers in/on the fly ash which are produced by the careful control of the combustion process.

The prior art fails to teach or suggest a process that includes the injection into the flue gas and collection therefrom of a solid material that catalytically affects the oxidation of mercury, and the injection into the flue gas and collection therefrom of a separate material that sorbs or sequesters oxidized mercury.

### SUMMARY

A mercury oxidation and capture process that includes providing combustion gases from a coal fired boiler, the combustion gases including an initial concentration of Hg(0); injecting into the combustion gases a sufficient quantity of a particulate mercury oxidant precatalyst; providing a sufficient residence time of the particulate mercury oxidant precatalyst in the combustion gases to convert the particulate mercury oxidant precatalyst to a oxidation catalyst; providing a sufficient residence time of the oxidation catalyst in the combustion gases to oxidize at least 80% of the Hg(0) concentration in the combustion gases to an oxidized mercury (e.g., Hg(I) and/or Hg(II)) before removal of the oxidation catalyst from contact with the combustion gases; removing the oxidation catalyst from contact with the combustion gases; injecting into the combustion gases an oxidized-mercury sorbent; and then collecting a oxidized-mercury/sorbent species.

### DESCRIPTION OF THE DRAWING

For a more complete understanding of the disclosure, reference should be made to the following detailed description and accompanying drawing figures wherein:

FIG. 1 is a comparative plot of the percent of mercury oxidized by the injection of the herein described particulate mercury oxidant precatalyst (PMOP) and calcium bromide.

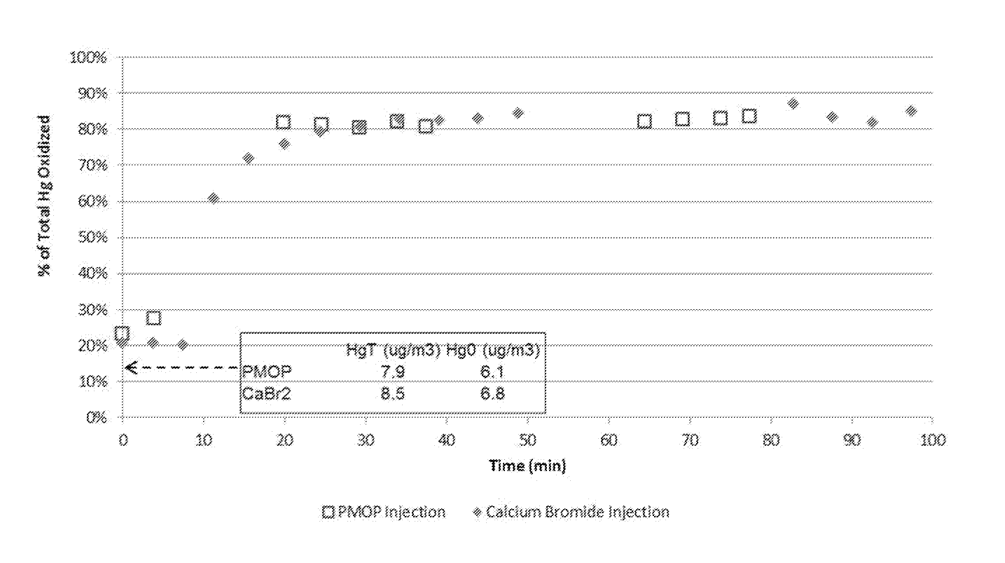

While specific embodiments are illustrated in the figures, with the understanding that the disclosure is intended to be descriptive of the invention, these embodiments are not intended to limit the invention described and illustrated herein.

### DETAILED DESCRIPTION

Described herein is a process of oxidizing mercury from Hg(0) to Hg (I) and/or Hg(II) while the mercury is suspended in a flue gas produced from a coal fired boiler and capturing the oxidized mercury for mercury sequestration and/or removal from the flue gas and boiler emissions. A first embodiment includes providing combustion gases from a coal fired boiler, the combustion gases including an initial concentration of Hg(0). Injecting into (e.g., admixing) the combustion gases a sufficient quantity of a particulate mercury oxidant precatalyst. Providing a sufficient residence time of the particulate mercury oxidant precatalyst in the combustion gases to convert the particulate mercury oxidant precatalyst to a oxidation catalyst and then providing a sufficient residence time of the oxidation catalyst in the combustion gases to oxidize at least 80% of the Hg(0) concentration in the combustion gases to an oxidized mercury (e.g., Hg(I) and/or Hg(II)) before removal of the oxidation catalyst from contact with the combustion gases. Removing the oxidation catalyst from contact with the combustion gases, for example by collection of the particles in a bag house or electrostatic precipitator. Injecting into the combustion gases an oxidized-mercury sorbent and collecting an oxidized-mercury/sorbent species.

Herein, there are used a variety of terms to distinguish between the components added to the flue gas, the components carried by the flue gas, and the components collected from the flue gas. For example, herein, the term particulate mercury oxidant precatalyst refers to a manufactured solid material that can be carried to and injected into the flue gas (combustion gases). Based on data that suggests a (brief) induction period before oxidation, it is hypothesized that the precatalyst is not the active oxidation catalyst in a catalytic cycle for the oxidation of mercury. That is, the material is a precatalyst as the term precatalyst is understood in the art. The term oxidation catalyst refers to the particulate materials formed, for example, from an initiation or activation reaction of the precatalyst and a reagent in the combustion gases (e.g., mercury, acid, or combinations thereof). The process described herein further calls for an oxidized-mercury sorbent, this refers to a material added to the combustion gases that preferentially sorbs (interacts, absorbs, collects, retains) oxidized mercury over reduced mercury (i.e., Hg(0)). The product of the sorption of the oxidized mercury by the oxidized-mercury sorbent is herein termed the oxidized-mercury/sorbent species. Notably, the structure and composition of the oxidized-mercury/sorbent species is dependent on the amount of oxidized mercury collected and the composition of the sorbent.

Another embodiment is a process for collecting Hg from a flue gas, the process comprising providing combustion gases from a coal fired boiler, the combustion gases including Hg(0); injecting into the combustion gases a particulate mercury oxidant precatalyst; oxidizing Hg(0) in the combustion gases to an oxidized mercury selected from the group consisting of Hg(I), Hg(II), and a mixture thereof; admixing the oxidized mercury and an oxidized-mercury sorbent to form a oxidized-mercury/sorbent species; and collecting, together or individually, the oxidation catalyst and the oxidized-mercury/sorbent species.

In one example of the embodiments, the particulate mercury oxidant precatalyst and the oxidized-mercury sorbent are admixed. The admixing of the particulate mercury oxidant precatalyst and the oxidized-mercury sorbent can occur in the flue gas (i.e., combustion gases) or can occur prior to injection of the materials into the flue gas (combustion gases). In one process, the particulate mercury oxidant precatalyst and the oxidized-mercury sorbent can be co-injected into the combustion gases. That is, the materials are admixed prior to the injection into the flue gas (combustion gases). The admixing can occur in a mixing apparatus or can occur in an injection nozzle. In another example of the process, the materials can be injected collinearly with the flow of the flue gas, the particulate mercury oxidant precatalyst can be injected upstream of the oxidized-mercury sorbent, or the oxidized-mercury sorbent can be injected upstream of the particulate mercury oxidant precatalyst injection location. In one preferable example, the oxidation catalyst and the oxidized-mercury sorbent are both carried by the flue gas prior to a solids collection apparatus.

The processes described in the embodiments can further include collecting solids from the flue gas. In one example, the processes can include collecting fly ash from the flue gas. Preferably, the processes include collecting an admixture of the oxidation catalyst and the oxidized-mercury/sorbent species. That is, the oxidation catalyst and the oxidized-mercury/sorbent species are co-collected by a particulate collection apparatus. The particulate collection apparatus can be, for example, an electrostatic precipitator (ESP), a cyclone separator, and/or a bag house. In another example, the oxidation catalyst and the oxidized-mercury/sorbent species are collected separately; for example, the oxidation catalyst can be collected by a solids collection apparatus and the oxidized-mercury sorbent can be added to the combustion gases downstream of this solids collection apparatus.

The particulate mercury oxidant precatalyst, preferably, includes a particulate support and a mercury oxidant. That is, the particulate mercury oxidant precatalyst is at least a two component material in solid form with a non-oxidizing particulate support (preferably including, very weakly oxidizing) which carries a mercury oxidant. The term mercury oxidant refers to the chemical compound or component carried by the particulate support that affects the oxidation of mercury, herein this species is referred to as the mercury oxidant or simply a compound carried by the particulate support.

The particulate support is preferably thermally stable at or above the temperature of the flue gas at the position in the flue gas conduit where the particulate mercury oxidant precatalyst is injected into the flue gas. Examples of particulate supports include silicates, aluminates, transition metal oxides, alkali metal oxides, alkali earth metal oxides, polymeric supports and mixtures thereof. Preferably, the particulate support is selected from the group consisting of phyllosilicates, allophane, graphite, quartz, and mixtures thereof. Even more preferably, the particulate support is a phyllosilicate selected from the group consisting of vermiculite, montmorillonite, bentonite, and kaoline. The examples include porous polymeric supports, microporous polymeric supports; porous silicates, aluminates, and/or aluminosilicates.

The mercury oxidant can be a direct oxidant or an indirect oxidant. Direct oxidants react with Hg(0) to yield Hg(I) or Hg(II); with or without other combustion gas components. That is, the oxidation of mercury with a direct oxidant occurs at the site of the mercury oxidant (carried by the particulate support). Indirect oxidants catalyze reactions that yield a direct oxidant. For example, an indirect oxidant can react with other components of the combustion gases to produce the direct oxidant. That is, the oxidation of mercury with an indirect oxidant occurs through the interaction of mercury with a species catalytically produced by the mercury oxidant species carried by the particulate support. The indirect oxidation can occur on the particulate support, in the flue gas (e.g., desorbed from the particulate surface), or a combination thereof.

Examples of the mercury oxidant (the compound or species carried by the particulate support) include copper sulfides, iron sulfides, calcium sulfides, sodium sulfides, sodium chloride, sodium sulfates, iron chlorides, calcium chlorides, sodium bromides, copper sulfates, and mixtures thereof. Preferably, the particulate support carries a compound selected from the group consisting of a copper sulfide, an iron sulfide, a calcium sulfide, and a mixture thereof.

The particulate mercury oxidant precatalyst preferably includes more (i.e., at least 50 wt. %) of the particulate support than the mercury oxidant. For example, the particulate mercury oxidant precatalyst can include about 1 wt. % to about 50 wt. %, 1 wt. % to about 25 wt. %, or about 1 wt. % to about 10 wt. % of the mercury oxidant. In one preferable example the particulate mercury oxidant precatalyst comprises a phyllosilicate carrying about 1 wt. % to about 25 wt. %, or about 1 wt. % to about 10 wt. % of a copper sulfide.

As the particulate mercury oxidant precatalyst is injected into the flue gas, the support of the oxidation catalyst in the flue gas is important for the reaction of the oxidant with the mercury. One method for supporting the oxidation catalyst in the flue gas is to provide a particulate mercury oxidant precatalyst having a small or very small particle size; preferably, where individual particles of the oxidation catalyst do not agglomerate or increase particle size after injection into the flue gas. Sufficiently small particle sizes can permit Brownian motion and prevent undesired settling of the oxidation catalyst from the flue gas. In one example, the particulate mercury oxidant precatalyst has an average particle size in the range of about 50 nm to about 200 μm, 1 μm, to about 150 μm, or 5 μm to about 100 μm, preferably the particulate mercury oxidant precatalyst has an average particle size that is less than about 500 μm, 400 μm, 300 μm, 200 μm, 100 μm, 75 μm, or 50 μm; more preferably, the particulate mercury oxidant precatalyst has an average particle size of about 400 μm, 300 μm, 200 μm, 100 μm, 75 μm, 50 μm, or 25 μm.

Another important aspect of the present disclosure is the sorption of the oxidized mercury and removal of the mercury from the flue gas. The sorption of the oxidized mercury is preferably by the addition or injection of a mercury sorbent into the flue gas, more preferably into flue gas already carrying the oxidized mercury, or co-injecting into the flue gas with the particulate mercury oxidant precatalyst, or injected into the flue gas prior to the injection of the particulate mercury oxidant precatalyst. In still another aspect, the oxidation catalyst can be collected by an electrostatic precipitator (ESP), the oxidized mercury passing through the ESP, and the mercury sorbent added downstream of the ESP. Examples of mercury sorbents include fly ash adapted for cationic mercury sorption, phyllosilicates adapted for cationic mercury sorption, carbon adapted for cationic mercury sorption, water based solutions adapted for cationic mercury sorption, and polymeric materials adapted for cationic mercury sorption. One particularly relevant mercury sorbent is activated carbon. Preferably, the mercury sorbent is an un-brominated powder activated carbon (i.e., a carbon adapted for cationic mercury sorption). Herein, the terms sorbent and sorption refer to the material and process of forming a new chemical species that carries the mercury, the mercury can be absorbed, adsorbed, or reacted with the sorbent to form the sorption product.

Another embodiment is the admixture of the particulate mercury oxidant precatalyst and the mercury sorbent. The admixture can include about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the particulate mercury oxidant precatalyst. Preferably, the admixture consists essentially of the particulate mercury oxidant precatalyst and the mercury sorbent, or consists of the particulate mercury oxidant precatalyst and the mercury sorbent. In one preferable example, the particulate mercury oxidant precatalyst includes a particulate support and a mercury oxidant. That is, the particulate mercury oxidant precatalyst is at least a two component material in solid form with a non-oxidizing (or very weakly oxidizing) particulate support which carries a mercury oxidant. In another example, the mercury sorbent can be a powdered activated carbon, a zeolite-based mercury sorbent (e.g., BASF Mercury Sorbent ZX), a supported mercury sorbent (e.g., the supported mercury sorbents provided in U.S. Pat. Nos. 8,025,160; 7,910,005; 7,871,524; 7,578,869; 7,553,792; and 7,510,992, the provided mercury sorbents incorporated herein by reference). The admixture can further include an alkali metal or alkali metal salt in an about less than about 10 wt. %, 5, wt. %, 2.5 wt. % or 1 wt. %.

The forgoing description is given for clearness of understanding only, and no unnecessary limitations should be understood therefrom, as modifications within the scope of the invention may be apparent to those having ordinary skill in the art.

1. A mercury oxidation and capture process comprising:
providing combustion gases from a coal fired boiler, the combustion gases including an initial concentration of Hg(0);
injecting a sufficient quantity of a particulate mercury oxidant precatalyst (PMOP) into the combustion gases (CG), thereby forming a CG/PMOP admixture;
providing a sufficient residence time of the particulate mercury oxidant precatalyst in the CG/PMOP admixture to convert the particulate mercury oxidant precatalyst to a oxidation catalyst (OC), thereby forming a CG/OC admixture;
providing a sufficient residence time of the oxidation catalyst in the CG/OC admixture to oxidize at least 80% of the Hg(0) concentration in the CG/OC admixture to an oxidized mercury before separating the oxidation catalyst and the combustion gases;
separating the oxidation catalyst and the combustion gases;
injecting into the combustion gases an oxidized-mercury sorbent; and then
collecting a oxidized-mercury/sorbent species.

2. The process of claim 1, wherein the particulate mercury oxidant precatalyst and the oxidized-mercury sorbent are co-injected into the combustion gases.

3. The process of claim 1, wherein the particulate mercury oxidant precatalyst is injected upstream of the injection of the oxidized-mercury sorbent.

4. The process of claim 1;
wherein the oxidized-mercury sorbent is a particulate; and the process further comprising collecting an admixture of the oxidation catalyst and the oxidized-mercury/sorbent species.

5. The process claim 1, wherein the particulate mercury oxidant precatalyst includes a particulate support.

6. The process of claim 5, wherein the particulate mercury oxidant precatalyst further comprises an oxidation promoter.

7. The process of claim 5, wherein the particulate support is selected from the group consisting of silicates, aluminates, transition metal oxides, polymeric supports and mixtures thereof; preferably wherein the particulate support is selected from the group consisting of phyllosilicates, allophane, graphite, quarts, and mixtures thereof; even more preferably wherein the particulate support is a phyllosilicate selected from the group consisting of vermiculite, montmorillonite, bentonite, and kaoline; wherein the particulate support, alone, has no mercury oxidation activity.

8. The process of claim 5, wherein the particulate support carries a compound selected from the group consisting of a copper sulfide, an iron sulfide, a calcium sulfide, and a mixture thereof.

9. The process of claim 5 wherein the particulate mercury oxidant precatalyst comprises a phyllosilicate carrying about 1 wt. % to about 25 wt. %, or about 1 wt. % to about 10 wt. % of a copper sulfide.

10. The process of claim 1 wherein the particulate mercury oxidant has a particle size of about 50 nm to about 100 μm.

11. The process of claim 1, wherein the oxidized-mercury sorbent comprises activated carbon.

12. The process of claim 11, wherein the oxidized-mercury sorbent comprises un-brominated, powder-activated carbon.

13. The process of claim 1, wherein the particulate mercury oxidant precatalyst is injected into the combustion gases upstream of an air heater.

14. The process of claim 13, wherein the oxidized-mercury sorbent is injected into the combustion gases downstream of the air heater.

15. The process of claim 1, wherein the oxidation catalyst is collected by an electrostatic precipitator (ESP); and wherein the oxidized mercury passes through the ESP.

16. The process of claim 1, wherein the particulate mercury oxidant precatalyst is injected into the flue gas at a rate of about 80 to about 160 lbs/hr.

17. The process of claim 16, wherein at least 82.5%, 85%, 87.5%, or 90% of the Hg(0) is oxidized.
